(19) United States
(12) Patent Application Publication
(10) Pub. No.: US 2014/0086388 A1
(43) Pub. Date: Mar. 27, 2014

(54) RADIATION GENERATING UNIT, RADIATION IMAGING SYSTEM AND TARGET

(71) Applicant: CANON KABUSHIKI KAISHA, Tokyo (JP)

(72) Inventors: Shuji Yamada, Atsugi-shi (JP); Takeo Tsukamoto, Kawasaki-shi (JP); Tadayuki Yoshitake, Tokyo (JP); Kazushi Nomura, Sagamihara-shi (JP)

(73) Assignee: CANON KABUSHIKI KAISHA, Tokyo (JP)

(21) Appl. No.: 14/022,377

(22) Filed: Sep. 10, 2013

(30) Foreign Application Priority Data
Sep. 25, 2012 (JP) 2012-210372

(51) Int. Cl. H01J 35/08; G01N 23/04

(52) U.S. Cl. CPC H01J 35/08; G01N 23/04
USPC 378/62; 378/121; 378/143

(57) ABSTRACT

A radiation generating unit of the present invention includes an electron beam source that emits an electron beam and can change the size of a region to be irradiated with the electron beam on a target while maintaining constant the center position of the region to be irradiated with the electron beam. Furthermore, a target is adopted where the number of types of target layers included in the region to be irradiated with the electron beam can be changed by changing the size of the region to be irradiated with the electron beam. The radiation quality can be switched without changing the radiation focus, and the radiation quality of a high energy radiation can be largely changed.

### BACKGROUND OF THE INVENTION

1. Field of the Invention

The present invention relates to a target that generates a radiation by being irradiated with an electron beam, a radiation generating unit including the target, and a radiation imaging system including the radiation generating unit.

2. Description of the Related Art

In the medical field, diagnostic imaging that uses dual-energy imaging has been known as one method among X-ray imaging methods of more clearly observing an affected area. The dual-energy imaging uses two types of X-rays with different energy distributions (radiation quality). As target layers, for instance, a radiation generating target (hereinafter, called a target) on which tungsten having a high atomic number is formed into a film, and a target on which molybdenum having a low atomic number is formed into a film are adopted. Both the targets are switched, an object is irradiated with X-rays, and projection data by X-rays from each target is collected. The projection data is subjected to weighted addition and subtraction processes and an image reconstruction process to thereby generate a highly precise image.

The targets can be mechanically switched. However, high speed switching is difficult. The targets are arranged in a vacuum container in a radiation tube. Accordingly, uncertainty remains about reliability of movable mechanisms in a high vacuum and maintenance of vacuum airtightness.

Japanese Patent No. 4326250 discloses an X-ray tube that uses a target provided with multiple types of target layers, electrostatically or magnetically deflects an electron beam emitted from an electron beam source, and irradiates the different target layers with the beam to thereby generate X-rays with different radiation quality.

U.S. Patent 2011/0150184 discloses an X-ray source where a step is provided between a central part and a peripheral part of a target layer to vary the thickness of the layer. A region to be irradiated with an electron beam is changed by an electromagnet arranged outside of the X-ray tube, and either one or both of the thin part and the thick part of the target layer are irradiated with an electron beam so as to change the radiation quality of generated X-rays.

Unfortunately, if the path of the electron beam is changed to vary a position to be irradiated with the electron beam, a deviation occurs in positional relationship between the center (radiation focus) of a radiation generating position and an object. Accordingly, errors occur in operation on pieces of projection data with respect to each other, and weighted addition and subtraction processes on reconstructed images with respect to each other. As a result, there are problems in that accuracy of a generated image is degraded, for instance, the contours of the acquired image become hazy.

Instead, in the case of changing the thickness of the target layer, a radiation generated at the thick part is strongly subjected to a filter effect because the transmission distance is long in the target layer. Accordingly, a low energy side is more selectively attenuated than a high energy side. As a result, the difference between the two radiation qualities increases on the low energy side, and decreases on the high energy side. For a medical purpose, radiation qualities are desirably distinctly different from each other on a high energy side equal to or above 20 kV to discriminate an affected area of living tissue. Radiations on the low energy side are typically shielded because the transmittance is low with respect to the radiation exposure amount.

### SUMMARY OF THE INVENTION

It is an object of the present invention to suppress a deviation in radiation focus caused by switching the radiation qualities, while allowing the radiation qualities of high energy radiations to be distinctly varied so as to enable a highly accurate image to be acquired by dual-energy imaging.

To achieve the object, a first aspect of the present invention provides a radiation generating unit comprising a storage container, a radiation tube arranged in the storage container, the radiation tube having a target which includes a substrate and multiple types of target layers that are provided on the substrate and generating a radiation by irradiating the target layers with an electron beam from an electron beam source, and a driving circuit arranged in the storage container, the driving circuit driving the radiation tube, wherein the electron beam source can change a size of a region to be irradiated with the electron beam on the target while maintaining constant a center position of the region to be irradiated with the electron beam, and the number of types of the target layers included together in the region to be irradiated with the electron beam can be changed by changing the size of the region to be irradiated with the electron beam.

Further features of the present invention will become apparent from the following description of exemplary embodiments with reference to the attached drawings.

### BRIEF DESCRIPTION OF THE DRAWINGS

FIG. 1 is a schematic diagram illustrating a configuration of a radiation generating unit of the present invention.

FIGS. 2A and 2B are schematic diagrams illustrating a target of a first embodiment of the present invention; FIG. 2A is a sectional view, and FIG. 2B is a plan view.

FIGS. 3A and 3B are schematic diagrams illustrating a target of a second embodiment of the present invention; FIG. 3A is a sectional view, and FIG. 3B is a plan view.

FIGS. 4A and 4B are schematic diagrams illustrating a target of a third embodiment of the present invention; FIG. 4A is a sectional view, and FIG. 4B is a plan view.

FIG. 5 is a block diagram illustrating a radiation imaging system of the present invention.

### DESCRIPTION OF THE EMBODIMENTS

Preferred embodiments of the present invention will hereinafter be described using drawings. Radiations used in the present invention are typically X-rays. Instead, γ-rays and neutron rays may also be adopted.

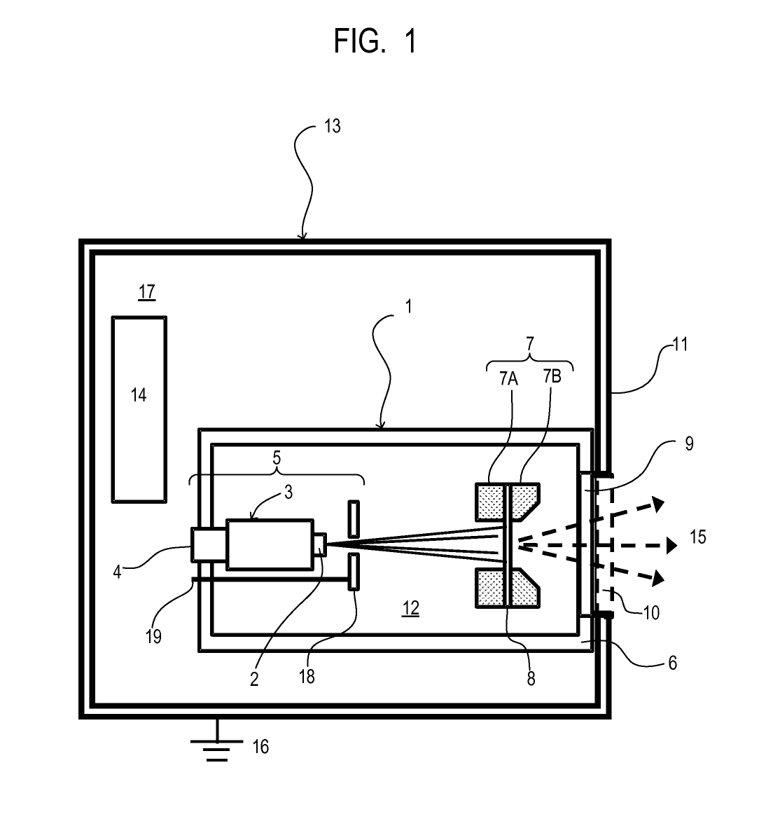

FIG. 1 is a schematic diagram illustrating a configuration of a radiation generating unit 13.

To drive a radiation tube 1, a driving circuit 14 is connected to an electron source 3 through a current introduction terminal 4, and also connected to a convergence electrode 18 through a voltage application terminal 19.

A storage container 11 stores the radiation tube 1 and the driving circuit 14, and is filled with insulative liquid 17. Furthermore, a ground terminal 16 is connected to this container. Strength is required for the material of the storage container 11. Accordingly, iron, stainless steel, and brass are desirable, for instance. A configuration may also be adopted where a member capable of shielding radiations, such as lead, is arranged over the entire periphery or a part of the storage container 11.

A radiation transmission window 10 is arranged at an opening of the storage container 11. Radiations generated by the radiation tube 1 are emitted out of the storage container 11 through the radiation transmission window 10. For the radiation transmission window 10, a material containing no heavy element, such as beryllium, carbon, diamond, glass, acrylic resin, and polymethyl methacrylate resin may be used.

The insulative liquid 17 can be highly electrical insulative, have a high cooling capability, and be resistant to thermal degradation. Electrical insulating oils, such as silicone oil, transformer oil and fluorinated oil, and fluorinated insulative liquid, such as hydro fluoro ether, may be adopted.

The radiation tube 1 includes an electron beam source 5, a target 8, a shield 7, a transmission window 9, and a vacuum container 6.

The electron beam source 5 includes: the electron source 3 provided with the current introduction terminal 4 at the rear end and an electron emitting portion 2 at the front end; and the convergence electrode 18 supplied with a voltage from the voltage application terminal 19. The electron beam source 5 can control the convergence state of an electron beam.

The electron source 3 may be a device that can control the amount of emitted electrons, from the outside of the vacuum container 6. A hot cathode electron source and a cold cathode electron source may be appropriately adopted. The electron source 3 is electrically connected to the driving circuit 14 provided outside of the vacuum container 6 such that the amount of electron emission and on and off states of electron emission can be controlled through the current introduction terminal 4 arranged to penetrate the vacuum container 6.

The electron source 3 includes the electron emitting portion 2. Electrons emitted from the electron emitting portion 2 become an electron beam having an energy of 20 to 150 keV, and can be incident onto the target 8 arranged so as to face the electron emitting portion 2. With respect to the potential (defined as a ground potential) of the target 8, the potential of the electron source 3 is −20 to −150 kV.

The convergence electrode 18 has a cylindrical shape, and is for changing the size of the diameter of a region to be irradiated, that is, the diameter of the electron beam (focal size), without changing the center position of a region to be irradiated with the electron beam onto the target 8.

The diameter of the electron beam with which the target 8 is irradiated can be reduced by decreasing reduction in potential of the convergence electrode 18 with respect to the potential (ground potential) of the target 8, using repulsion of electron beams. In contrast, the diameter of the electron beam can be increased by increasing reduction in potential of the convergence electrode 18 to weaken repulsion of electron beams. More specifically, the potential can be switched as follows. Provided that the potential of the electron source 3 is −100 kV, the potential of the convergence electrode 18 is set to −98 kV, to reduce the diameter of the electron beam; and the potential is set to −99 kV, to increase the diameter of the electron beam. Thus, it is arranged such that the electron beam passes through the center of the convergence electrode 18, and the potential of the convergence electrode 18 is controlled to change the diameter of the electron beam. This control can change the size of the region to be irradiated with the electron beam, while maintaining constant the center position of the region on the target 8 to be irradiated with the electron beam. The center of the region to be irradiated with the electron beam is the centroid of a plate assuming the plate has a uniform thickness and a shape identical to the region which is irradiated with the electron beam.

The shield 7 includes a rear shield 7A and a front shield 7B respectively arranged at a rear and a front of the target 8. The rear shield 7A has a cylindrical shape provided with an electron beam introduction hole for introducing the electron beam onto the target 8. The front shield 7B has a cylindrical shape where an opening is formed for emitting a radiation 15 generated at the target 8 by irradiation of the electron beam. The opening has a flare shape having a diameter increasing in the direction of emitting the radiation so as to allow the radiation to be emitted while gradually spreading. The shield 7 allows the generated radiation to be emitted only toward the front where a necessary radiation region to be irradiated is formed; for this purpose, the shield 7 shields radiations emitted in the other directions. Accordingly, the material of the shield 7 can be electrically conductive and thermally conductive, and shield radiations generated at 20 to 150 kV. For instance, any of tungsten, tantalum, molybdenum, zirconium and niobium, and alloys thereof may be adopted. The shield 7 is designed to be arranged in the vacuum container 6 together with the target 8, which is provided separated from the transmission window 9. Instead, in the case where the target 8 is a transmission type target as illustrated, the transmission window 9 may be made of the target 8, and the shield 7 may be provided around the target 8 configuring the transmission window 9. That is, a configuration may be adopted where the rear shield 7A and the front shield 7B protrude inward and outward of the radiation tube 1 from the peripheries of both sides of the target 8.

The shield 7 and the target 8 can be connected to each other by brazing, not illustrated. A brazing filler may be appropriately selected in consideration of the material of the shield 7 and a temperature limit. For instance, in the case where the target 8 may be at a high temperature, Cr—V series, Ti—Ta—Mo series, Ti—V—Cr—Al series, Ti—Cr series, Ti—Zr—Be series, and Zr—Nb—Be series can be selected as a high melting point brazing filler metal. Instead, a brazing filler metal that includes Au—Cu as a principal ingredient, nickel filler metal, brass filler metal, silver filler metal, and palladium filler metal may be used.

The vacuum container 6 stores the electron beam source 5, the target 8 and the shield 7, and may be made of any of glass and ceramics. The inside of the vacuum container 6 is an inner space 12 that is decompressed and evacuated.

With respect to the mean free path of electrons, the distance between the electron source 3 and the target 8 that emits radiations is defined such that the inner space 12 has at least a degree of vacuum that allows electrons to fly; a degree of vacuum of 1×10⁻⁴ Pa or less is applicable. The degree of vacuum can be appropriately selected in consideration of the electron source to be used and operation temperature. In the case of a cold cathode electron source, a degree of vacuum of 1×10⁻⁶ Pa or less is more desirable. To maintain the degree of vacuum, a getter, not illustrated, may be arranged in the inner space or an auxiliary space, not illustrated, that communicates with the inner space 12.

### First Embodiment

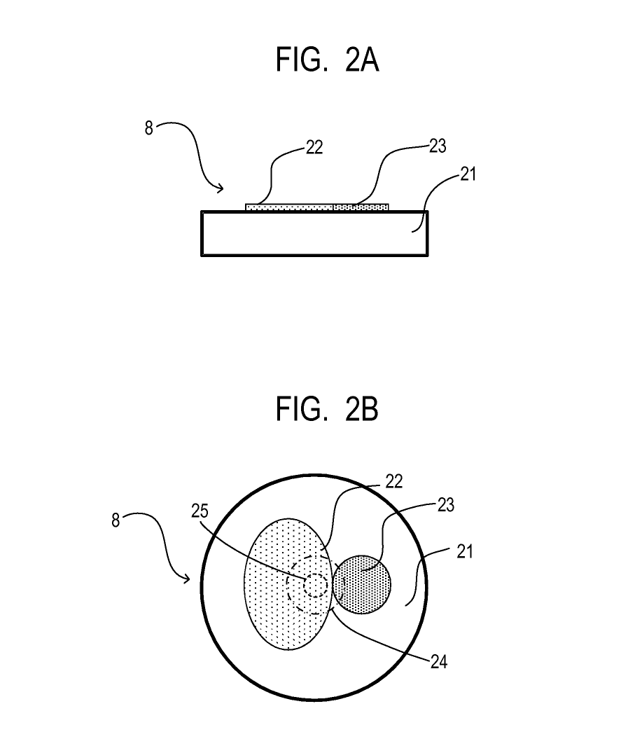

As illustrated in FIGS. 2A and 2B, the target 8 is designed such that multiple types of target layers formed of different materials, i.e., a first target layer 22 and a second target layer 23, are formed on a surface of the substrate 21. The substrate 21 can be desirably formed of diamond, beryllium, and carbon that do not affect occurring radiations.

The constituent materials of the first and second target layers 22 and 23 may be any of tungsten, molybdenum, rhodium, tantalum, and niobium that have a high atomic number and a high melting point, and alloys thereof with another element material. Selection and combination of materials having atomic numbers apart by at least two can largely change the resulting energy distribution. Accordingly, although the first and second target layers 22 and 23 may be made of combination of elements having adjacent atomic numbers, the layers may desirably be combination of metals having atomic numbers apart by at least two or combination of alloys thereof.

The arrangement of the first and second target layers 22 and 23 on the substrate 21 can change the number of types of target layers included together in the region to be irradiated with an electron beam, by changing the size of the region to be irradiated with the electron beam. More specifically, the arrangement is defined such that only the first target layer 22 exists in the region to be irradiated with an electron beam in the case of narrowing the electron beam in diameter, and both the first target layer 22 and the second target layer 23 exist in the region to be irradiated with an electron beam in the case of enlarging the electron beam in diameter. The target layers are formed by any of the sputtering method and the vapor deposition method, which are typical thin film forming methods. The film thicknesses of the target layers are 100 nm to 100 μm. The layers are desirably provided on the same surface of the substrate 21 at the same thickness. Pattern formation of the target layers can be performed using typical masks. For highly accurate pattern formation, a little larger film may be deposited, a resist mask may be formed by lithography, and etching may further be performed so as to arrange the shape.

FIG. 2B illustrates a circumferential line 24 of the region to be irradiated with an electron beam in the case of enlarging the electron beam in diameter, and a circumferential line 25 of the region to be irradiated with an electron beam in the case of narrowing the electron beam in diameter. Each of the lines has a circular shape. In the case of narrowing an electron beam in diameter, a radiation is generated only from the first target layer 22. In the case of enlarging an electron beam in diameter, both the first target layer 22 and the second target layer 23 are irradiated with the electron beam, and the number of types of target layers irradiated with the electron beam is thus increased. As a result, a radiation having composite energy characteristics of the first target layer 22 and the second target layer 23 can be emitted. A configuration that can select the ratio of areas in the region to be simultaneously irradiated with an electron beam on the first target layer 22 and the second target layer 23 can adjust the composite energy characteristics of the first target layer 22 and the second target layer 23.

### Second Embodiment

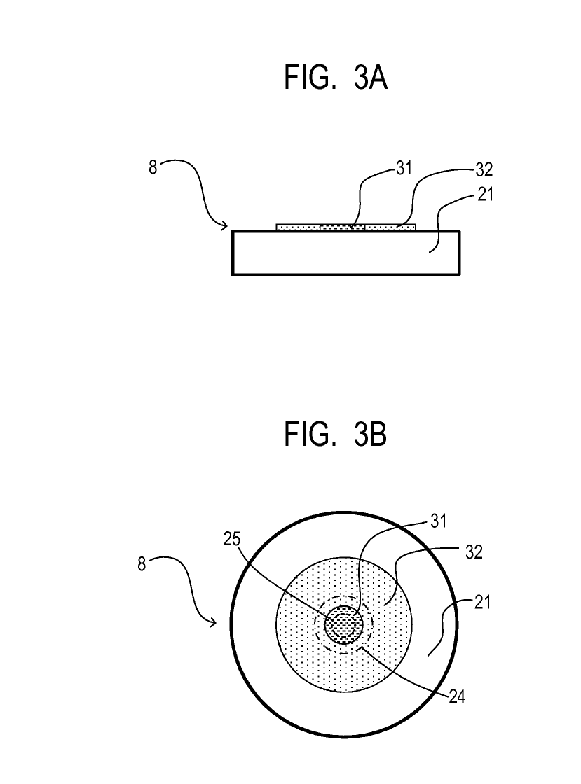

FIGS. 3A and 3B illustrate a target 8 of a second embodiment. A first target layer 31 and a second target layer 32 are provided in the same thickness on an identical surface of a substrate 21 in a concentric circular manner relative to the center of the region to be irradiated with an electron beam. Reference numeral 24 illustrates a circumferential line of the region to be irradiated with an electron beam enlarged in diameter, and reference numeral 25 illustrates a circumferential line of the region to be irradiated with an electron beam narrowed in diameter. According to this configuration, when the electron beam is narrowed in diameter, a radiation is generated only from the first target layer 31. In contrast, when the electron beam is enlarged in diameter, a radiation having composite energy characteristics of the first target layer 31 and the second target layer 32 is emitted point-symmetrically with respect to the center of the region to be irradiated with the electron beam. A configuration that can select the ratio of areas in the region to be simultaneously irradiated with an electron beam on the first target layer 31 and the second target layer 32 can adjust the composite energy characteristics of the first target layer 31 and the second target layer 32.

### Third Embodiment

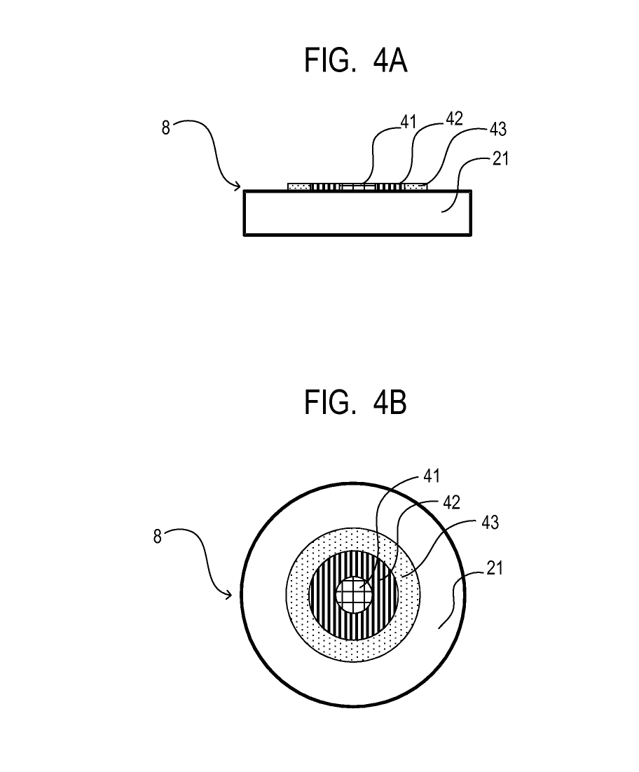

FIGS. 4A and 4B illustrate a target 8 of a third embodiment. A first target layer 41 and a second target layer 42 are provided in the same thickness on an identical surface of a substrate 21 in a concentric circular manner relative to the center of the region to be irradiated with an electron beam. In addition, a third target layer 43 is further arranged in the same thickness in a concentric circular manner relative to the center of the region to be irradiated with an electron beam. According to this configuration, change in diameter of the electron beam can arbitrarily select from among three types that include a radiation only from the first target layer 41, a radiation having composite energy characteristics of the first target layer 41 and the second target layer 42, and a radiation having composite energy characteristics of the first target layer 41, the second target layer 42 and the third target layer 43. Each of the radiations having the composite energy characteristics is emitted point-symmetrically with respect to the center of the region to be irradiated with an electron beam. A configuration that can select the ratio of areas in the region to be simultaneously irradiated with an electron beam on the target layers 41 to 43 can adjust the composite energy characteristics of the target layers 41 to 43.

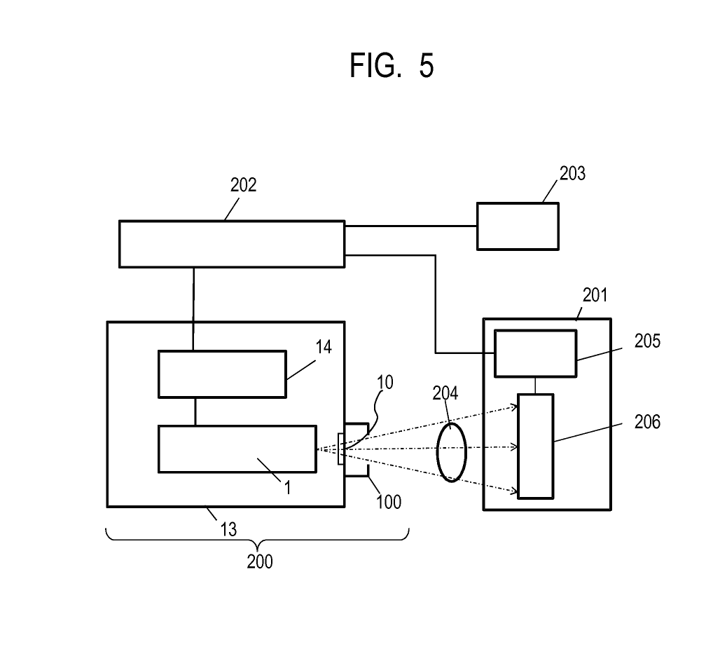

Referring to FIG. 5, one example of a radiation imaging system according to the present invention will be described.

A radiation generating apparatus 200 includes a radiation generating unit 13, and a movable diaphragm unit 100 provided at a radiation transmission window 10. The movable diaphragm unit 100 has a function of adjusting the size of an area irradiated with a radiation by the radiation generating unit 13. This unit desirably has a light projection targeting function that simulates the area to be irradiated with a radiation using visible light.

A system controlling apparatus 202 controls the radiation generating apparatus 200 and a radiation detecting apparatus 201 in a cooperative manner. The driving circuit 14 outputs various control signals to the radiation tube 1 under control of the system controlling apparatus 202. The control signals control the emission state of a radiation emitted from the radiation generating apparatus 200. The radiation emitted from the radiation generating apparatus 200 passes through an object 204, and is detected by a detector 206. The detector 206 converts the detected radiation into an image signal, and outputs the converted signal to a signal processing section 205. The signal processing section 205 applies prescribed signal processing to the image signal, and outputs the processed image signal to the system controlling apparatus 202, under control of the system controlling apparatus 202. The system controlling apparatus 202 outputs a display signal for causing a display apparatus 203 to display an image to the display apparatus 203, based on the processed image signal. The display apparatus 203 displays, on a screen, the image based on the display signal as a taken image of the object 204. The radiation imaging system can be applied for non-destructive inspection on industrial products, and pathological diagnosis on human bodies and animals.

The radiation generating unit of the present invention can change the size of a region that is to be irradiated with an electron beam formed on a target while maintaining constant the center position of the region to be irradiated with the electron beam. Accordingly, change in size of the region to be irradiated with an electron beam without deviating the focal position of the radiation can vary the radiation quality of a generated radiation. The variation in radiation quality is due to the type of the target irradiated with an electron beam. Accordingly, a large variation in radiation quality of a high energy radiation can be achieved.

The radiation imaging system of the present invention can acquire projection data by at least two types of radiations in a short time period without movement of an object. Accordingly, a highly accurate image can be taken.

Furthermore, according to the target of the present invention, the center of a region to be irradiated with an electron beam coincides with the center of multiple target layers arranged in a concentric circular manner. The coincidence allows radiations having different energy characteristics to be uniformly emitted point-symmetrically. Accordingly, even in operation between pieces of projection data acquired by switching regions to be irradiated with electron beams, a highly efficiently generated image can be acquired without causing nonuniformity errors at edges of an image. Furthermore, even in the case of correcting data, the computational load can be reduced.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-210372, filed Sep. 25, 2012, which is hereby incorporated by reference herein in its entirety.

What is claimed is:

1. A radiation generating unit comprising a storage container; a radiation tube arranged in the storage container, the radiation tube having a target which includes a substrate and multiple types of target layers that are provided on the substrate and generating a radiation by irradiating the target layers with an electron beam from an electron beam source; and a driving circuit arranged in the storage container, the driving circuit driving the radiation tube,
wherein the electron beam source can change a size of a region to be irradiated with the electron beam on the target while maintaining constant a center position of the region to be irradiated with the electron beam, and the number of types of the target layers included together in the region to be irradiated with the electron beam can be changed by changing the size of the region to be irradiated with the electron beam.

2. The radiation generating unit according to claim 1, wherein the multiple types of the target layers of the target are arranged such that, when the region to be irradiated with the electron beam is enlarged in size, the number of types of the target layers included inside of the region to be irradiated with the electron beam increases.

3. The radiation generating unit according to claim 1, wherein a ratio of areas of different types of the target layers included in the region to be irradiated with the electron beam can be selected by changing the size of the region to be irradiated with the electron beam.

4. The radiation generating unit according to claim 1, wherein the region to be irradiated with the electron beam has a circular shape, and the multiple types of the target layers are provided on an identical surface of the substrate in a same thickness and in a concentric circular manner with respect to a center of the region to be irradiated with the electron beam.

5. The radiation generating unit according to claim 1, wherein the target layer is formed of any of tungsten, molybdenum, rhodium, tantalum and niobium, and alloys thereof.

6. The radiation generating unit according to claim 1, wherein the multiple types of the target layers are formed of metals having atomic numbers apart by at least two or alloys thereof.

7. The radiation generating unit according to claim 1, wherein the electron beam source can change the size of the region to be irradiated with the electron beam on the target by changing a convergence state of the electron beam.

8. The radiation generating unit according to claim 7, wherein the electron beam source comprises a convergence electrode that changes the convergence state of the electron beam by adjusting a potential.

9. The radiation generating unit according to claim 8, wherein the convergence electrode has a cylindrical shape allowing the electron beam to pass through an inside of the electrode.

10. The radiation generating unit according to claim 1, wherein the target is a transmission type target including the substrate formed of a radiation transmissive material.

11. The radiation generating unit according to claim 10, wherein the target constitutes a transmission window provided at the radiation tube for acquiring the generated radiation.

12. The radiation generating unit according to claim 10, wherein the substrate is made of any of diamond, beryllium and carbon.

13. The radiation generating unit according to claim 10, wherein shields are provided so as to protrude from around both surfaces of the target.

14. A radiation imaging system, comprising:
a radiation generating unit comprising a storage container, a radiation tube arranged in the storage container, the radiation tube having a target which includes a substrate and multiple types of target layers that are provided on the substrate and generating a radiation by irradiating the target layers with an electron beam from an electron beam source, and a driving circuit arranged in the storage container, the driving circuit driving the radiation tube;
a radiation detecting apparatus that detects the radiation having been emitted from the radiation generating unit and passed through an object; and
a control apparatus that controls the radiation generating unit and the radiation detecting apparatus in a cooperative manner,
wherein the electron beam source can change a size of a region to be irradiated with the electron beam on the target while maintaining constant a center position of the region to be irradiated with the electron beam, and, the target comprises multiple types of target layers arranged such that the number of types of the target layers included together in the region to be irradiated with the electron beam can be selected by changing the size of the region to be irradiated with the electron beam.

15. A target comprising a target layer provided on a substrate, the target layer being irradiated with an electron beam to generate a radiation,
wherein multiple types of target layers are provided in a same thickness on an identical surface of the substrate in a concentric circular manner.

16. The target according to claim 15, the target layer is formed of any of tungsten, molybdenum, rhodium, tantalum and niobium, and alloys thereof.

17. The target according to claim 15, wherein the multiple types of the target layers are formed of metals having atomic numbers apart by at least two or alloys thereof.

18. The target according to claim 15, wherein the target is a transmission type target including the substrate formed of a radiation transmissive material.

19. The target according to claim 18, wherein the substrate is made of any of diamond, beryllium and carbon.
